(19) United States
(12) Patent Application Publication
(10) Pub. No.: US 2017/0336950 A1
(43) Pub. Date: Nov. 23, 2017

(54) INFORMATION PROCESSING DEVICE AND CHARACTERISTIC DISPLAY METHOD

(71) Applicant: FUJITSU LIMITED, Kawasaki-shi (JP)

(72) Inventors: Takamasa Shinde, Kawasaki (JP); Akira Sakai, Kawasaki (JP); Akihiro Otsuka, Yokohama (JP); Kazuhisa Inagaki, Yokohama (JP); Hideharu Matsushita, Yokohama (JP); Akira Ueda, Yokohama (JP); Tetsuyuki Kubota, Yokohama (JP); Yasuhiro Ite, Chofu (JP)

(73) Assignee: FUJITSU LIMITED, Kawasaki-shi (JP)

(21) Appl. No.: 15/583,039

(22) Filed: May 1, 2017

(30) Foreign Application Priority Data
May 20, 2016 (JP) 2016-101704

(51) Int. Cl. G06F 3/0484; G06F 3/0481

(52) U.S. Cl. CPC G06F 3/04845; G06F 3/04817; G06F 2203/04803

(57) ABSTRACT

A non-transitory computer-readable recording medium has stored therein a program for causing a computer to execute a process for displaying a characteristic, the process includes displaying, on a display, a main screen indicating a first characteristic in a first area of an object to be analyzed; and displaying, on the display, a sub-screen indicating a second characteristic in a second area in the object, the second characteristic being different from the first characteristic, the second area being specified within the main screen, the sub-screen being overlapped on a portion within the main screen, the portion being corresponding to a portion of the second area in the first area.

### CROSS-REFERENCE TO RELATED APPLICATION

This application is based upon and claims the benefit of priority of the prior Japanese Patent Application 2016-101704, filed on May 20, 2016, the entire contents of which are incorporated herein by reference.

### FIELD

The embodiments discussed herein are related to a non-transitory computer-readable recording medium having stored therein a characteristic display program, an information processing device, and a characteristic display method.

### BACKGROUND

Numerical value analysis in which a physical phenomenon is analyzed by a computer has been widely performed for various physical phenomena as targets because of improvement of the performance of various pieces of hardware that constitute the computer.

The physical phenomenon is typically a coupled phenomenon in which two or more types of phenomena are mutually influenced each other. When numerical value analysis for such a coupled phenomenon as a target has been performed, a result of the numerical value analysis is obtained for two or more types of characteristics, for example, physical amounts such as air flow, temperature, and pressure.

Each of the two or more types of physical amounts obtained by the numerical value analysis is displayed on a display unit as a distribution map such as an isometric map/level map (contour diagram) or a vector diagram. The user refers to the various distribution maps displayed on the display unit, grasps the distribution statuses of the two or more types of the characteristics, and comprehensively evaluates the result of the numerical value analysis.

Japanese Laid-open Patent Publication No. 8-329042 and Japanese Laid-open Patent Publication No. 2007-193526 are examples of related art.

### SUMMARY

According to an aspect of the invention, a non-transitory computer-readable recording medium having stored therein a program for causing a computer to execute a process for displaying a characteristic, the process including displaying, on a display, a main screen indicating a first characteristic in a first area of an object to be analyzed; and displaying, on the display, a sub-screen indicating a second characteristic in a second area in the object, the second characteristic being different from the first characteristic, the second area being specified within the main screen, the sub-screen being overlapped on a portion within the main screen, the portion being corresponding to a portion of the second area in the first area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a display state of a main screen and sub-screens that respectively indicate a first characteristic and a second characteristic in an embodiment in order to explain the outline of an embodiment;

FIG. 2 is a block diagram illustrating a hardware configuration of an information processing device having a characteristic display function according to the embodiment;

FIG. 3 is a block diagram illustrating a functional configuration of the information processing device having the characteristic display function according to the embodiment;

FIG. 4 is a flowchart schematically illustrating an operation of the information processing device having the characteristic display function according to the embodiment;

FIG. 5 is a flowchart illustrating display processing of the main screen in the embodiment;

FIG. 6 is a flowchart illustrating display processing of the sub-screen and a reduced screen in the embodiment;

FIG. 7 is a flowchart illustrating screen switching processing due to an operation for the reduced screen in the embodiment;

FIG. 8 is a flowchart illustrating processing which makes display contents of the sub-screen and the reduced screen follow at the time of a movement operation of the sub-screen in the embodiment;

FIG. 9 is a diagram illustrating an example of a display state of the main screen indicating a vector diagram of a flow rate distribution as a first characteristic;

FIG. 10 is a diagram illustrating an example of a display state when the sub-screen indicating a contour diagram of a temperature distribution is displayed on the main screen illustrated in FIG. 9 as a second characteristic;

FIG. 11 is a diagram illustrating an example of a display state of the main screen indicating a contour diagram of an air flow distribution as a first characteristic;

FIG. 12 is a diagram illustrating an example of a display state of the main screen indicating a contour diagram of a temperature distribution as the first characteristic;

FIG. 13 is a diagram illustrating an example of a display state of the main screen indicating a contour diagram of a pressure distribution as the first characteristic;

FIG. 14 is a diagram illustrating an example of a display state when the reduced screen and a sub-screen indicating the contour diagram of the temperature distribution as the second characteristic are displayed on the main screen illustrated in FIG. 11; and

FIG. 15 is a diagram illustrating an example a display state when the second characteristic displayed on the sub-screen is switched from the contour diagram of the temperature distribution to the contour diagram of the pressure distribution through an operation for the reduced screen in the display state illustrated in FIG. 14.

### DESCRIPTION OF EMBODIMENTS

Each of two or more types of the physical amounts that have been obtained by the numerical value analysis as described in the background is basically displayed on each of different screens (windows) of the display unit.

Therefore, when a user refers to and compares different physical amounts, the user switches distribution maps displayed on the screen of the display unit or arranges and displays two or more distribution maps corresponding to two or more types of physical amounts on the display unit in parallel.

Thus, the user roughly estimates a position of the same area on the different distribution maps while switching the distribution maps or comparing the distribution maps displayed in parallel. In addition, the user refers to and grasps distribution statuses of the different physical amounts at the estimated same area, and comprehensively evaluates a result of the numerical value analysis.

Therefore, it is difficult for the user to accurately grasp the different physical amounts in a desired area (for example, the above-described same area), and it takes a lot of time to comprehensively evaluate the result of the numerical value analysis, and an evaluation accuracy of the numerical value analysis result is reduced.

Accordingly, it is desired to provide an apparatus and a method in which different characteristics in a desired area may be easily grasped visually.

Embodiments of a non-transitory computer-readable recording medium having store therein a program of characteristic display program, an information processing device for characteristic display, and a characteristic display method of the technology discussed herein are described below in detail with reference to drawings. However, the embodiments described below are merely examples, and there is no intention to exclude various modifications and applications of the technology that are not explicitly described in the embodiments. That is, the embodiments may be implemented so as to be modified in various ways without departing from the gist. In addition, there is no intention that each of the drawings includes merely configuration elements illustrated in the drawing, but each of the drawing may include other functions. In addition, the embodiments may be combined as appropriate so long as the processing contents do not conflict.

### <1> Overview of an Embodiment

When an existing technology is used, as described above, the user estimate approximate positions of the same area on the different distribution maps, grasps the distribution statuses of the different physical amounts of the estimated same area, and comprehensively evaluates the result of the numerical value analysis. Therefore, it is difficult for the user to accurately grasp the different physical amounts in the same area.

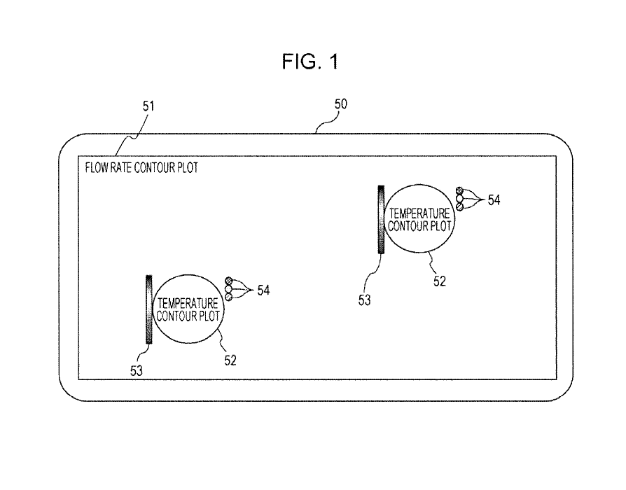

Therefore, in an embodiment, the display is performed as follows. The overview of the embodiment is described below with reference to FIG. 1. FIG. 1 is a diagram illustrating an example of a display state of a main screen 51 indicating a first characteristic and sub-screens 52 indicating a second characteristic in the embodiment. The characteristic (or physical characteristic), the first characteristic, and the second characteristic may be respectively referred to as a physical amount, a first physical amount, and a second physical amount. The main screen may be referred to as a master screen or a master window, and the sub-screen may be referred to as a sub-screen or a sub window.

As illustrated in FIG. 1, in the embodiment, there displays on display unit 50 the main screen 51 indicating a first characteristic in a first area (a main area) of a display target (an analysis target). The first area is, for example, an area of the entire substrate on which a plurality of components is mounted. The main screen 51 may be the entire area of the display screen in the display unit 50, and may be a single window displayed on the display screen. The first area (main area) is displayed within the main screen 51. The first characteristic corresponds to, for example, a flow rate contour diagram or a flow rate vector diagram corresponding to a flow rate distribution.

At this time, as illustrated in FIG. 1, in the embodiment, the sub-screen 52 indicating a second characteristic in a second area (sub area) specified within the main screen 51 by the user is displayed on the display unit 50 so as to overlap the position on the main screen 51, which corresponds to the second area. The second area is an area in the first area and narrower than the first area. The second area is, for example, a desired area including a component on a substrate, on which the user focuses. The second characteristic is a second physical amount having a different type from the first characteristic, and corresponds to, for example, a contour diagram or a vector diagram corresponding to a distribution of temperature, pressure, air flow, stress, magnetic flux density, Lorentz force, or the like. In addition, it is sufficient that the sub-screen 52 includes at least the second area specified by the user, but in the embodiment, the sub-screen 52 has the same size and shape as the second area.

In FIG. 1, an example is illustrated in which two second areas are specified by the user. Therefore, in the main screen 51, the sub-screen 52, a color scale 53, and icons 54 are displayed for each of the two second areas. That is, the two sub-screens 52 for the two second areas that have been specified by the user are displayed on the display unit 50 so as to overlap the positions on the main screen 51, which respectively corresponds to the second areas. In addition, the color scale 53 used for objective determination of color in each of the sub-screens 52 is displayed in the vicinity of each of the sub-screens 52. The display of the color scale 53 is omitted when objective determination of color is unnecessary for grasping a content of the sub-screen 52. A plurality of icons 54 are displayed in the vicinity of each of the sub-screens 52 and is described later, where three icons 54 are illustrated at corresponding position.

In FIG. 1, an example is described in which both of the two sub-screens 52 display a temperature distribution as a second characteristic, but the two sub-screens 52 may display characteristics different from each other. Three or more sub-screens 52 may be displayed.

In FIG. 1, the sub-screen (second area) 52 is a circle screen enclosed by a circle frame border. In this case, the user may specify a circular area that has a certain radius and is centered on a desired point as the second area 52 as a desired area by specifying the desired point within the main screen 51, that is, the first area through a mouse operation such as a click, a double-click, or the like. At this time, the user may use a value set by the user as the certain radius, or may use a default value as the certain radius.

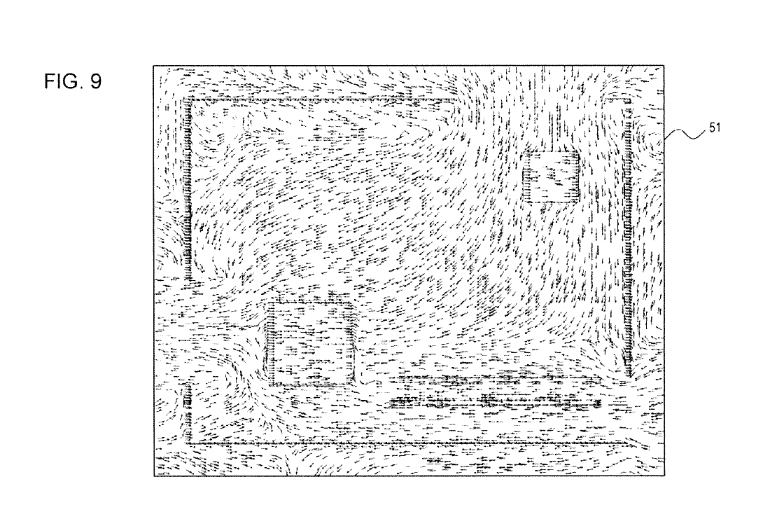

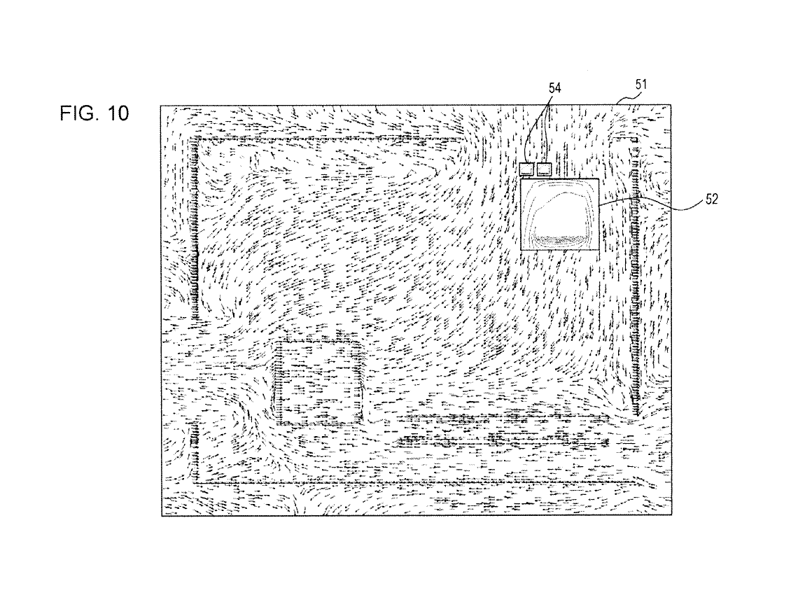

As the sub-screen 52, instead of the circle screen, a rectangle screen enclosed by a rectangle frame border may be used (see FIGS. 10, 14, and 15). In this case, the user may specify a rectangular area with desired two points as vertices on the diagonal line of the rectangular area as the second area 52 by specifying the desired two points with the main screen 51, that is, the first area through a mouse operation such as a click, a double-click, drag, and the like.

In addition, in the embodiment, when the sub-screen 52 is moved on the main screen 51 through a mouse operation such as a drag operation or the like of the user, the following control of a display state of the sub-screen 52 is performed on the display unit 50. That is, a second characteristic displayed on the sub-screen 52 in an area (first area) as a display target is displayed on the sub-screen 52, following the movement of the sub-screen 52 on the main screen 51.

In addition, in the embodiment, when two or more types of characteristics (physical amounts) are obtained as the result of the numerical value analysis, one or more icons 54, three icons in FIG. 1, are displayed in vicinity of each of the sub-screens 52 through the display unit 50. When n (n is a natural number) types of characteristics are obtained, at least n−1 icons 54 are displayed. That is, a plurality of icons 54 respectively corresponding to different types of a plurality of characteristics including the above-described first characteristic and second characteristic are displayed with each of the sub-screens 52 through the display unit 50.

For example, when four types of characteristics (physical amounts) A to D are obtained as the result of the numerical value analysis, three icons 54 are displayed. In addition, when it is assumed that the characteristic A is flow rate, the characteristic B is temperature, and the characteristics C and F are characteristics other than the flow rate and the temperature, in FIG. 1, the main screen 51 illustrates flow rate (characteristic A), and both of the two sub-screens 52 indicate the temperature (characteristic B), and the three icons 54 respectively correspond to the characteristics A, C, and D.

At this time, in the embodiment, a characteristic corresponding to a single icon 54 selected from the plurality of icons 54 is displayed on the sub-screen 52 through the display unit 50 as the second characteristic, in which the selection is performed through a mouse operation of the user, such as a click, a double click, or the like.

In addition, in the embodiment, a reduced screen (thumbnail) obtained by reducing the sub-screen 52 is used as the icon 54, and the reduced screen as the icon 54 is displayed through the display unit 50 when each of the icons 54 has been selected.

In addition, in the embodiment, when the sub-screen 52 is moved on the main screen 51 through a mouse operation of the user such as a drag or the like, the following control of the display state of each of the icons 54 is performed on the display unit 50. That is, the second characteristic in the area (first area) of the display target through which the sub-screen 52 passes due to the movement of the sub-screen 52 is made to follow the movement of the sub-screen 52 and displayed on the reduced screen (thumbnail) as each icon 54 through the display unit 50.

In the embodiment, when a certain icon 54 has been selected from the plurality of icons 54 through a mouse operation of the user such as a click, a double click, or the like, background processing described below is executed. In parallel with execution of the processing for displaying the characteristic indicated by the selected icon 54, there is generated in advance the display data for displaying the sub-screen 52 which displays the characteristics corresponding the icons other than the selected icon 54.

As described above, the sub-screen 52 is overlapped at the position corresponding to the second area indicated as the desired area on the main screen 51 at which the first characteristic is displayed. At the second area, there is displayed the sub-screen 52 indicating the second characteristic having the different type from the first characteristic. As a result, it becomes easy for the user to visually grasp the characteristic displayed on the desired area different from the characteristic displayed on the main screen 51. Thus, it may be possible to greatly reduce a time for evaluating comprehensively the results of the numerical value analysis, and to greatly improve the evaluation accuracy of the numerical value analysis result.

In addition, when the user moves the sub-screen 52 by operation of the mouse, it may be possible to display the second characteristic, following movement of the sub-screen 52 and the icons 54, and to display the second characteristic of the end position of the movement. As a result, it becomes easy for the user to visually grasp different characteristics on the desired area while moving the sub-screen 52. Thus, a time taken to comprehensively evaluate the result of the numerical value analysis may be further reduced, and the evaluation accuracy of the numerical value analysis result may be further improved.

In addition, in a case in which the user selects a characteristic that is to be displayed on the sub-screen 52, the user may grasp a content displayed on the sub-screen 52 when an icon 54 has been selected by referring to the reduced screen (thumbnail) as the icon 54. Thus, a desired characteristic in a desired area may be selected and displayed reliably.

In addition, when a certain icon 54 has been selected through a mouse operation of the user, display data used to display a sub-screen 52 indicating a characteristic other than a characteristic corresponding to the certain icon 54 is generated in advance, in the background processing. As a result, display data of a characteristic that is probably selected next and displayed on the sub-screen 52 is generated in advance, so that a characteristic desired by the user may be displayed on the sub-screen 52 in a short time when the user has selected an icon 54 corresponding to the desired characteristic. Thus, a time taken to comprehensively evaluate the result of the numerical value analysis may be further reduced.

In addition, at this time, a second area smaller than the first area is an area to be processed for generating display data, and it is possible to narrower the area to be processed compared to generate display data for the whole area as the first area. Accordingly, it may be possible to greatly shorten the time necessary for the process of display.

### <2> a Configuration of the Information Processing Device Having the Characteristic Display Function

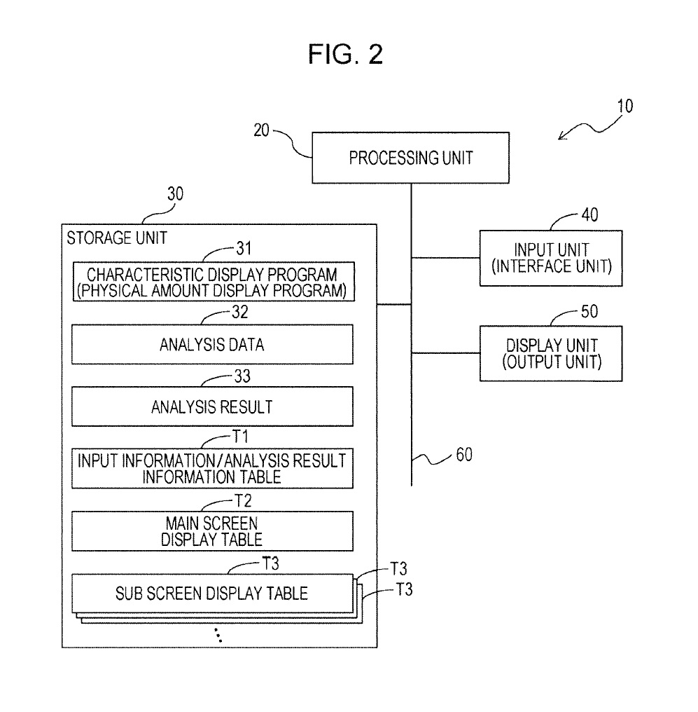

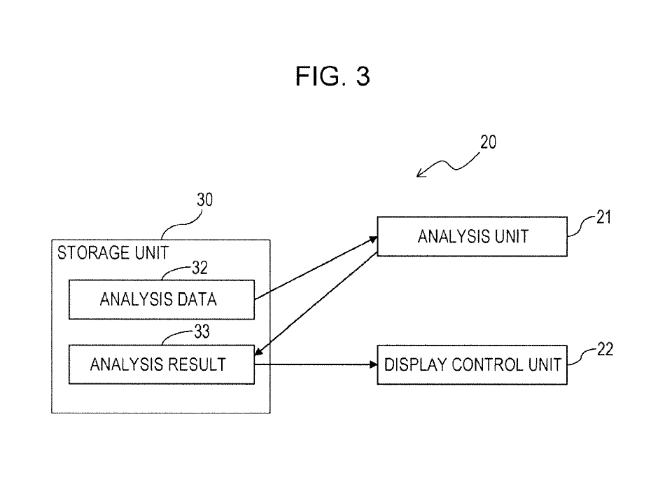

With reference to FIGS. 2 and 3, there is described below a hardware configuration and a functional configuration of the information processing device 10 having the characteristic display function such as the physical amount display function according to the embodiment. FIG. 2 is a block diagram illustrating the hardware configuration of the information processing device 10 according to the embodiment. FIG. 3 is a block diagram illustrating the functional configuration of the processing unit 20 in the information processing device 10 according to the embodiment.

As illustrated in FIG. 2, for example, the information processing device (computer) 10 according to the embodiment has the characteristic display function (physical amount display function) that displays various characteristics (various physical amounts). The various characteristics or the various physical amounts are included in a numerical value analysis result obtained by analyzing physical phenomena. The information processing device 10 includes the processing unit 20, a storage unit 30, an input unit 40, and the display unit 50. The processing unit 20, the storage unit 30, the input unit 40, and the display unit 50 are coupled to each other through a bus 60 so as to communicate with each other.

The processing unit 20 controls the entire information processing device 10. The processing unit 20 may be a single processor or a multi-processor. The processing unit 20 may be, for example, any one of a central processing unit (CPU), a micro processing unit (MPU), a digital signal processor (DSP), an application specific integrated circuit (ASIC), a programmable logic device (PLD), and a field programmable gate array (FPGA). In addition, the processing unit 20 may be obtained by combining two or more types of elements from among the CPU, the MPU, the DSP, the ASIC, the PLD, and the FPGA.

The storage unit 30 stores various pieces of data desired for processing by the processing unit 20. As the various pieces of data, for example, the storage unit 30 includes a program in addition to analysis data 32, an analysis result 33, and tables T1, T2, and T3. As the program, the storage unit 30 may include an operating system (OS) program and an application program that the processing unit 20 is caused to execute. In the application program, a characteristic display program (physical amount display program) 31 may be included. As the storage unit 30, a random access memory (RAM) or a hard disk drive (HDD) may be used, or a semiconductor storage device such as a flash memory (solid state drive: SSD) may be used.

The program that the processing unit 20 is caused to execute may be recorded in a non-transitory portable recording medium such as an optical disk, a memory device, or a memory card. The program stored in the portable recording medium may be executed, for example, by the control through the processing unit 20 after having been installed into the storage unit 30. In addition, the processing unit 20 may also execute the program by reading the program from the portable recording medium directly.

The optical disk is a portable non-transitory recording medium in which data is recorded so as to be readable by reflection of light. As the optical disk, there are a Blu-ray (registered trademark), a digital versatile disc (DVD), a DVD-random access memory (RAM), a compact disc read only memory (CD-ROM), CD-R (Recordable)/RW (ReWritable), and the like. The memory device is a non-transitory recording medium including a communication function with a device connection interface (not illustrated), and is, for example, a universal serial bus (USB) memory. The memory card is a card-type non-transitory recording medium to and from which data is written and read by being coupled to the processing unit 20 through a memory reader writer (not illustrated).

The input unit 40 includes, for example, a keyboard or a mouse, and issues various instructions to the processing unit 20 through an operation by the user. Instead of the mouse, a touch panel, a tablet, a touch pad, a trackball, or the like may be used. In addition, the input unit 40 may include an interface unit used to couple the information processing device 10 to various recording mediums, various networks, and the like in order to input various pieces of data such as the characteristic display program 31, the analysis data 32, and the analysis result 33, to the information processing device 10.

The display unit 50 is, for example, a display device using a cathode ray tube (CRT), a liquid crystal display device, or the like, and displays information related to various pieces of processing by the processing unit 20. In addition, the display unit 50 may be an output unit that prints the information related to the various pieces of processing by the processing unit 20.

As illustrated in FIG. 3, the processing unit 20 according to the embodiment functions as an analysis unit 21 by executing a certain application program (not illustrated) stored in the storage unit 30 or the like, and also functions as the display control unit 22 by executing the characteristic display program 31. The above-described certain application program and the characteristic display program 31 may be provided so as to be integrated into a single program, or may be provided as different programs separately.

The analysis unit 21 performs numerical value analysis on an analysis target (for example, the entire substrate on which a plurality of components is mounted), based on the analysis data 32 stored in the storage unit 30, and stores the result of the numerical value analysis in the storage unit 30 as the analysis result 33.

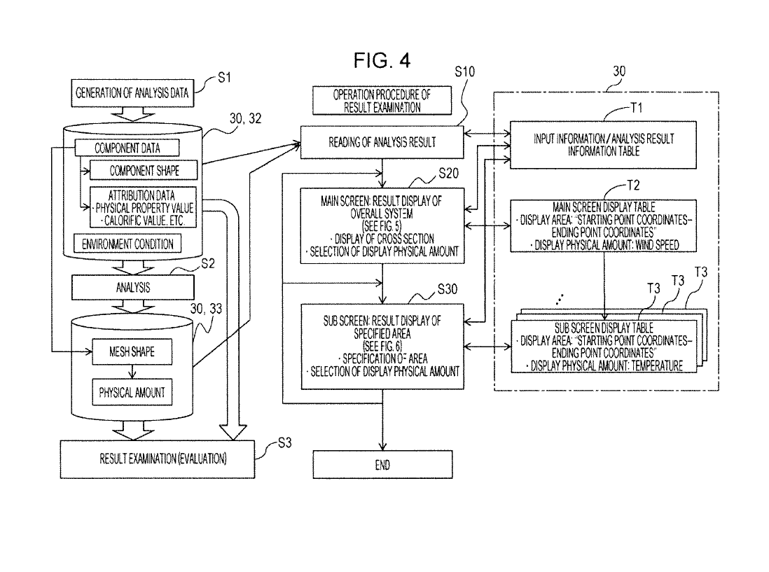

The analysis data 32 includes component data and an environment condition (see FIG. 4). The component data includes a component shape and attribute data such as physical property values, calorific values, and the like. The environment condition is a condition of an environment in which the analysis target is installed, and may include, for example, temperature, humidity, pressure, and the like. The analysis data 32 may be generated in the information processing device 10 (processing unit 20), or may be generated in a further information processing device (not illustrated) different from the information processing device 10. When the analysis data 32 is generated in the further information processing device, the analysis data 32 is obtained from the further information processing device through the input unit (interface unit) 40 and stored in the storage unit 30.

The analysis result 33 includes a mesh shape and physical amounts (characteristics) (see FIG. 4). Here, as the physical amounts (characteristics), the analysis result 33 includes two or more types of characteristics that have been obtained by the numerical value analysis of the analysis unit 21, for example, physical amounts such as air flow (flow rate), temperature, and pressure. The analysis result 33 includes data of the first characteristic (first physical amount) and data of the second characteristic (second physical amount) that correspond to the display target in the display unit 50.

The function of the analysis unit 21 included in the information processing device 10 may be included in a further information processing device (not illustrated) different from the information processing device 10. In this case, the analysis result 33 for the analysis target corresponding to the display target is obtained from the further information processing device through the input unit (interface unit) 40 and stored in the storage unit 30.

A display control unit 22 controls the display state of the display unit 50. In particular, the display control unit 22 controls the display state of the display unit 50 based on the analysis data 32 and the analysis result 33, and various pieces of information/various instructions input from the input unit 40 in order to achieve the characteristic display function in the embodiment.

The display control unit 22 controls the display state of the display unit 50 so that there is displayed, on the display unit 50, the main screen 51 indicating the first characteristic (for example, air flow) in the first area of the display target, that is, the analysis target (see FIGS. 1 and 9 to 15). For example, the first characteristic and the first area of the display target are specified from the input unit 40 through an operation of the user.

The display control unit 22 controls the display state of the display unit 50 to display, on the display unit 50, the sub-screen 52 (see FIGS. 1, 10, 14, and 15) indicating the second characteristic, such as temperature, pressure, or the like, in the second area specified within the main screen 51 so that the sub-screen 52 overlaps the portion corresponding to the second area on the main screen 51. For example, the position and dimension of the second area and the second characteristic are specified from the input unit 40 through an operation of the user. As described above, the second area may be a circle screen enclosed by a circle frame border or a rectangle screen enclosed by a rectangle frame border, or a screen having a shape other than the circle and the rectangle.

At this time, the display control unit 22 generates the main screen 51 indicating data of the first characteristic, which is included in the analysis result 33, that has been read from the storage unit 30, and controls the display state of the display unit 50 so as to display the generated main screen 51 on the display unit 50.

In addition, when the display control unit 22 accepts a specification of a range of the second area within the main screen 51, the display control unit 22 reads data included in the analysis result 33 of the second characteristic in the accepted range of the second area from the storage unit 30 and generates the sub-screen 52. In addition, the display control unit 22 generates a display screen in which the generated sub-screen 52 overlaps the position of the second area on the main screen 51, and controls the display state of the display unit 50 so as to display the generated display screen through the display unit 50.

When the sub-screen 52 is moved on the main screen 51, the display control unit 22 controls the display state of the display unit 50 as follows. The display state of the display unit 50 is controlled so that the second characteristic in the display target area, as an area to be displayed, through which the sub-screen 52 passes is displayed on the sub-screen 52 on the display unit 50 so as to follow the movement of the sub-screen 52. The movement of the sub-screen 52 on the main screen 51 is performed by the operation of the user through the input unit 40.

The display control unit 22 controls the display state of the display unit 50 so that the display unit 50 displays, with the sub-screen 52, the plurality of icons 54 respectively corresponding to different types of a plurality of characteristics including the first characteristic and the second characteristic (see FIGS. 1, 10, 14, and 15). At this time, the display control unit 22 controls the display state of the display unit 50 so that a characteristic corresponding to a certain icon 54 selected from the plurality of icons 54 is displayed on the sub-screen 52 through the display unit 50 as the second characteristic. The selection of the certain icon 54 from the plurality of icons 54 is performed, for example, through an operation for the input unit 40 by the user.

The display control unit 22 displays the icon(s) 54 each of which is a reduced screen (thumbnail) that is obtained by reducing the sub-screen 52 displayed on the display unit 50 when each of the icons 54 is selected.

In the case of using the above described thumbnail(s), when the sub-screen 52 is moved on the main screen 51, the display control unit 22 controls the display state of the display unit 50 as follows. The display state of the display unit 50 is controlled so that the second characteristic(s) in the display target area, as an area to be displayed, through which the sub-screen 52 passes is or are displayed on the reduced screen as the thumbnail(s) for the icon(s) 54 on the sub-screen 52 in the display unit 50 so as to follow the movement of the sub-screen 52.

The display control unit 22 generates display data by the background processing when a certain icon 54 has been selected from the plurality of icons 54 through an operation for the input unit 40 by the user. That is, the display control unit 22 generate, in advance, display data used to display a sub-screen 52 indicating a characteristic other than a characteristic corresponding to the certain icon 54 from among the plurality of characteristics, in parallel with processing in which the characteristic corresponding to the selected certain icon 54 is displayed on the sub-screen 52.

The display control unit 22 controls the display states of the main screen 51 and the sub-screen 52 in the display unit 50 while managing various pieces of information using the input information/analysis result information table T1, the main screen display table T2, and the sub-screen display table T3 stored in the storage unit 30.

The input information/analysis result information table T1 may be used when the display control unit 22 generates display data used to display the main screen 51 and the one or more sub-screens 52 for the display target (analysis target) on the display unit 50. In the input information/analysis result information table T1, various pieces of input information included in the analysis data 32 and various pieces of information included in the analysis result 33 are stored.

In the main screen display table T2, there is stored main screen display information used to display a certain main screen 51 through the display control unit 22. As the main screen display information, there is stored “starting point coordinates-ending point coordinates” such as two vertex coordinates on the diagonal line of the rectangle main screen indicating a display area of the main screen 51 and data of a display physical amount (first characteristic including, for example, wind speed) in the main screen display table T2 (see FIG. 4).

The sub-screen display table T3 is generated for each of the sub-screens 52 and stores sub-screen display information used to display the sub-screen(s) 52 through the display control unit 22. The sub-screen display information is “starting point coordinates-ending point coordinates” indicating a display area of the sub-screen 52 and a display physical amount (second characteristic including, for example, temperature) (see FIG. 4). When the shape of each of the sub-screens 52 is a rectangle, two vertex coordinates on the diagonal line of the rectangle are stored as “starting point coordinates-ending point coordinates”, for example, in the sub-screen display table T3. In addition, when the shape of each of the sub-screens 52 is a circle as illustrated in FIG. 1, the center coordinates of the circle and the radius of the circle are stored as “starting point coordinates-ending point coordinates”, for example, in the sub-screen display table T3.

### <3> an Operation of the Information Processing Device Having the Characteristic Display Function According to the Embodiment

An operation of the information processing device 10 having the characteristic display function according to the embodiment is described below with reference to FIGS. 4 to 8.

First, it is schematically described the operation of the information processing device 10 having the characteristic display function (physical amount display function) according to the embodiment with reference to the flowchart illustrated in FIG. 4 (Steps S1 to S3 and S10 to S30).

Before performance of an operation by the characteristic display function according to the embodiment, in the information processing device 10, numerical value analysis for the analysis target is performed by the analysis unit 21, based on the analysis data 32 stored in the storage unit 30 (Steps S1 and S2).

At this time, as described above, the analysis data 32 is generated by the processing unit 20 of the information processing device 10 or a further information processing device (Step S1), and stored in the storage unit 30.

In addition, in the embodiment, the numerical value analysis for the analysis target is performed by the analysis unit 21, based on the analysis data 32 (Step S2), and the result, such as a mesh shape, various physical amounts, and the like, of the numerical value analysis is stored in the storage unit 30 as the analysis result 33.

After that, the user causes the display unit 50 to display the main screen 51 and the sub-screen 52 using the characteristic display function according to the embodiment in the information processing device 10. In addition, the user grasps the distribution of two or more types of characteristics with reference to the main screen 51 and the sub-screen 52, and comprehensively evaluates and examines the result of the numerical value analysis (Step S3). Steps S10 to S30 indicate an operation procedure at the time of the result examination in Step S3.

At the time of result examination of the numerical value analysis, first, various types of input information included in the analysis data 32 and various types of information included in the analysis result 33 are read and stored in the input information/analysis result information table T1 (Step S10). The display control unit 22 refers to the input information/analysis result information table T1, and generates display data used to display the main screen 51 and the sub-screen 52 for the display target through the display unit 50, based on the referred information (Steps S20 and S30).

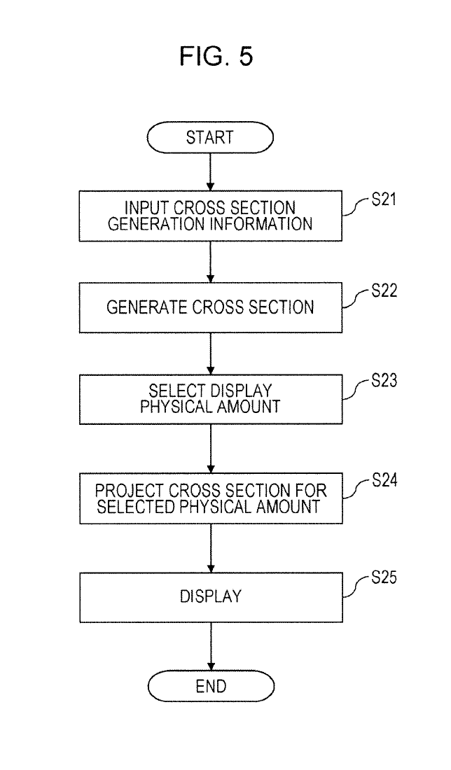

In Step S20, the overall result for the first area (for example, the entire substrate) as the display target and the first characteristic (display physical amount including, for example, wind speed) specified by the user is displayed on the main screen 51 through the display unit 50. That is, the display control unit 22 generates the entire image of a desired cross section of the display target that has been selected by the user, and generates a distribution map (for example, wind speed contour diagram) in the above-described desired cross section for the first characteristic that has been selected by the user and projects the distribution map to the above-described entire image. At this time, display information of the main screen 51, that is, “starting point coordinates-ending point coordinates” indicating the display area of the main screen 51 and a display physical amount (first characteristic including, for example, wind speed) are stored in the main screen display table T2. The display processing of the main screen 51 in Step S20 is described later with reference to FIG. 5.

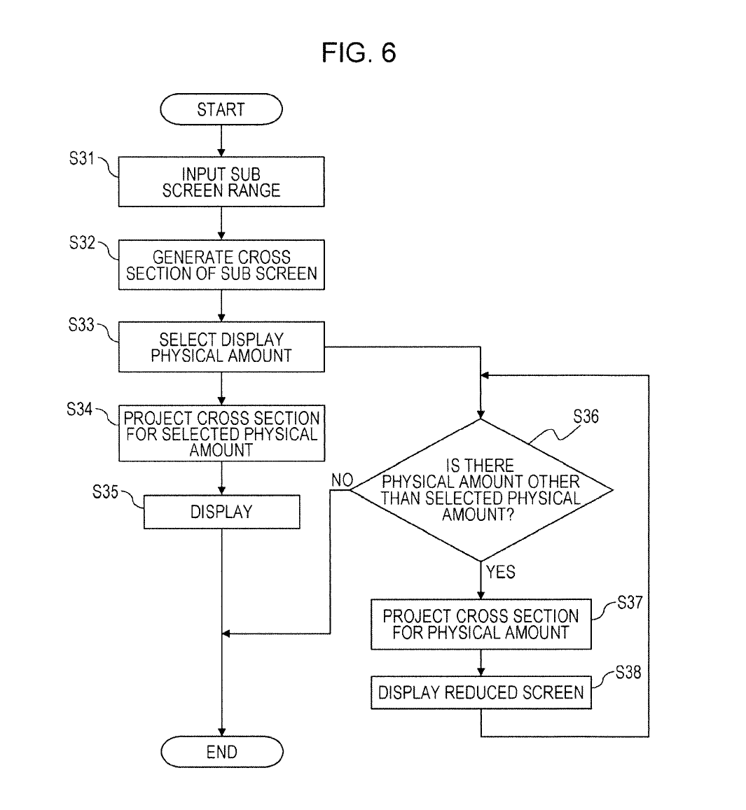

In Step S30, a specified area result for the second area (for example, an area including a desired component on the substrate) and the second characteristic (display physical amount including, for example, temperature and pressure) that has been specified by the user are displayed on the sub-screen 52 on the main screen 51 through the display unit 50. That is, the display control unit 22 displays the sub-screen 52 indicating the second characteristic in the second area specified within the main screen 51 through the display unit 50 so that the sub-screen overlaps the position on the main screen 51, which corresponds to the second area. At this time, the display information of the sub-screen 52, that is, “starting point coordinates-ending point coordinates” indicating the display area of the sub-screen 52 and the display physical amount (second characteristic including, for example, temperature and pressure) are stored in the sub-screen display table T3. The display processing of the sub-screen 52 in Step S30 is described later with reference to FIG. 6.

When the second area and the second characteristic are changed after the processing of Step S30, in the display control unit 22, the flow returns to the processing of Step S30. In addition, when the display target as an analysis target and a first area and the first characteristic are changed, in the display control unit 22, the flow returns to the processing of Step S20.

The display processing, step S20 of FIG. 4, of the main screen 51 in the embodiment is described below with reference to steps S21 to S25 in the flowchart illustrated in FIG. 5.

The display control unit 22 reads information used to generate the entire image of a desired cross section of the display target that has been selected by the user through the input unit 40, from the input information/analysis result information table T1 and performs input of the information (Step S21). In addition, the display control unit 22 generates the entire image of the desired cross section, based on the information that has been input in Step S21 (Step S22).

In addition, the display control unit 22 prompts the user to select a first characteristic (display physical amount) that is to be displayed, through the display unit 50, and causes the user to select the first characteristic (for example, wind speed) that is to be displayed (Step S23). In addition, the display control unit 22 generates a distribution map (for example, wind speed contour diagram) in the above-described desired cross section for the first characteristic that has been selected by the user through the input unit 40, and projects the distribution map to the above-described entire image (Step S24).

After that, the display control unit 22 displays, on the main screen 51, the above-described entire image to which the distribution map has been projected while managing the display information of the main screen 51 by using the main screen display table T2 (Step S25).

The display processing of the sub-screen 52 and the icon 54 as a reduced screen or a thumbnail in the embodiment is described below with reference to steps S31 to S38 in the flowchart illustrated in FIG. 6.

When a range of the sub-screen 52 as the second area is input and specified on the main screen 51 by the user through the input unit 40 (Step S31), the display control unit 22 generates an image as a partial image of a cross section of the position corresponding to the specified sub-screen 52, with reference to the input information/analysis result information table T1 (Step S32).

In addition, the display control unit 22 prompts the user to select a second characteristic (display physical amount) that is to be displayed, through the display unit 50, and causes the user to select the second characteristic (for example, temperature) that is to be displayed (Step S33). In addition, the display control unit 22 generates a distribution map (for example, temperature contour diagram) in the above-described cross section for the second characteristic that has been selected through the user through the input unit 40, and projects the distribution map to the above-described partial image (Step S34).

After that, the display control unit 22 displays, on the main screen 51, the above-described partial image to which the above-described distribution map has been projected while managing the display information of the sub-screen 52 by using the sub-screen display table T3 (Step S35). At this time, the display control unit 22 displays the sub-screen 52 indicating the second characteristic (for example, temperature or pressure) in the second area specified within the main screen 51 on the display unit 50 so that the sub-screen 52 overlaps the position, corresponding to the second area, on the main screen 51.

In addition, when the display physical amount is selected in Step S33, the display control unit 22 determines whether there is a physical amount other than the selected display physical amount that has been selected in Step S33 (Step S36). When there is no physical amount other than the selected display physical amount (NO in Step S36), the display control unit 22 ends the display processing of the sub-screen 52.

When there is a physical amount other than the selected display physical amount (YES in Step S36), the display control unit 22 generates a distribution map (for example, wind speed contour diagram or pressure contour diagram) in the above-described cross section for the physical amount (for example, wind speed or pressure) other than the selected display physical amount, and projects the distribution map to the above-described partial image (Step S37).

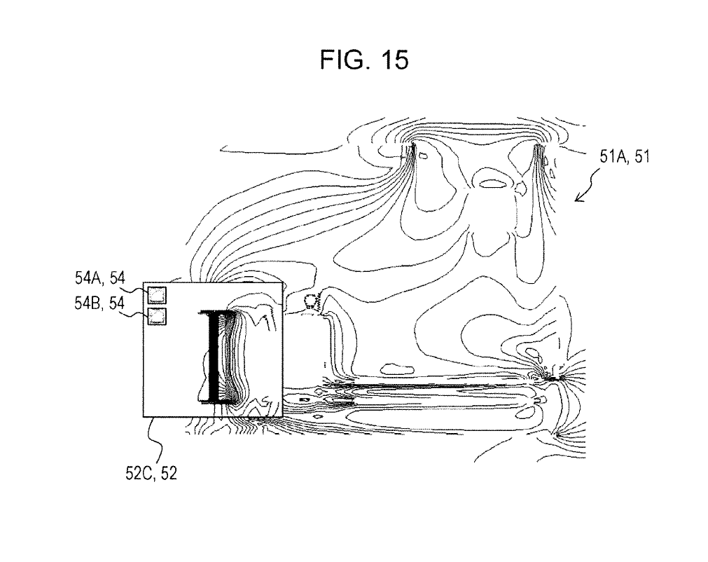

After that, the display control unit 22 generates a reduced screen as a thumbnail that has been obtained by reducing, to the icon size or the thumbnail size, the above-described partial image to which the above-described distribution map has been projected. In addition, the display control unit 22 displays the reduced screen within the sub-screen 52 (see FIGS. 14 and 15) or in the vicinity of the sub-screen 52 (see FIGS. 1 and 10) as the icon 54 (Step S38), and the flow returns to the processing of Step S36.

In the embodiment, the display data used to display the sub-screen 52 indicating the physical amount other than the selected display physical amount is generated in advance by execution of the processing of Steps S36 to S38 in parallel with the processing of Steps S34 and S35, and stored in the storage unit 30. That is, the display data is generated in the background processing.

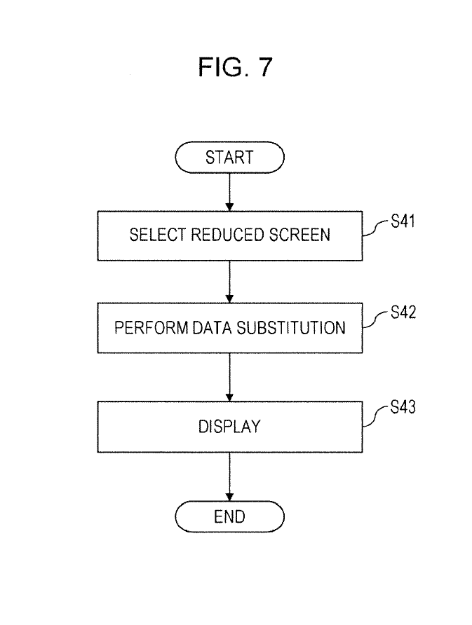

Screen switching processing according to an operation for switching the reduced screens (thumbnails) as the icons 54 in the embodiment is described below with reference to the flowchart illustrated in FIG. 7 (Steps S41 to S43).

When a certain icon (reduced screen) 54 is selected by the user through the input unit 40 in the state in which the sub-screen 52 and the icons 54 are displayed on the main screen 51 as described above (Step S41), the display control unit 22 performs data substitution, that is, switching processing of the sub-screen 52 (Step S42).

That is, the display control unit 22 controls the display state of the display unit 50 so that a physical amount (for example, pressure) corresponding to the selected certain icon 54 is displayed on the sub-screen 52 through the display unit 50 as a second characteristic. At this time, the display control unit 22 reads the display data used to display the sub-screen 52 indicating the physical amount (for example, pressure) corresponding to the selected certain icon 54, which has been generated in advance, from the storage unit 30, and substitutes the display data that is being displayed with the read display data (Step S42). As a result, the sub-screen 52 is displayed so that the display content is switched (Step S43). At this time, the reduced screen as the icon 54 displayed with the sub-screen 52 is also changed due to the switching of the above-described display content.

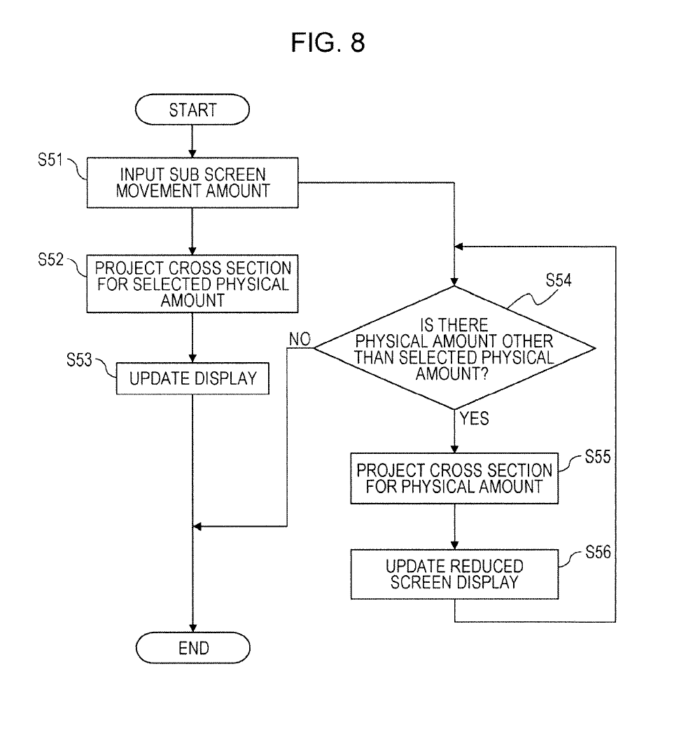

With reference to the flowchart illustrated in FIG. 8 (Steps S51 to S56), there is described below the processing in which display contents of the sub-screen 52 and the reduced screen 54 are made to follow the movement of the sub-screen 52 which is being moved.

When the sub-screen 52 is moved on the main screen 51 by the user through the input unit 40 in the state in which the sub-screen 52 and the icons 54 are displayed on the main screen 51 as described above, the display control unit 22 operates as follows.

When the user moves the sub-screen 52 on the main screen 51 through a mouse operation (for example, drag) or the like, a movement amount of the sub-screen 52 is input to the display control unit 22 (Step S51). When the movement amount of the sub-screen 52 is input to the display control unit 22, the display control unit 22 generates an image as a partial image of a cross section at a position to which the sub-screen 52 has been moved, and generates a distribution map of the cross section for a physical amount that is being selected and project the distribution map to the partial image (Step S52).

After that, the display control unit 22 updates the display state of the sub-screen 52 so that the partial image to which the distribution map has been projected is displayed on the main screen 51 while managing the display information of the sub-screen 52 by using the sub-screen display table T3 (Step S53).

At this time, the display control unit 22 displays the sub-screen 52 indicating the second characteristic (for example, temperature or pressure) in the second area specified within the main screen 51, through the display unit 50 so that the sub-screen 52 overlaps the position corresponding to the second area on the main screen 51.

As described above, the second characteristic in the area of the display target which moves due to the movement of the sub-screen 52 may be made to follow the movement of the sub-screen 52 and displayed on the sub-screen 52 through the display unit 50.

In addition, when the movement amount of the sub-screen 52 is input to the display control unit 22 in Step S51, the display control unit 22 determines whether there is a physical amount other than the selected display physical amount (Step S54). When there is no physical amount other than the selected display physical amount (NO in Step S54), the display control unit 22 ends the following processing of the sub-screen 52.

When there is a physical amount other than the selected display physical amount (YES in Step S54), the display control unit 22 generates a distribution map of the cross section for the physical amount other than the selected display physical amount and projects the distribution map to the partial image (Step S55).

After that, the display control unit 22 generates a reduced screen (thumbnail) that has been obtained by reducing, to the icon size or the thumbnail size, the partial image to which the distribution map has been projected. In addition, the display control unit 22 updates the current image to the image in which the reduced screen as the icon 54 is displayed within the sub-screen 52 or in the vicinity of the sub-screen 52 (Step S56), and the flow returns to the processing of Step S54.

In the embodiment, the processing of Steps S54 to S56 in parallel with the processing of Steps S52 and S53 is executed to generate in advance the display data used to display the sub-screen 52 indicating the physical amount other than the selected display physical amount, and the generated display data is stored in the storage unit 30. That is, the display data is generated in the background processing.

As described above, the second characteristic in the area of the display target which moves due to the movement of the sub-screen 52 may be made to follow the movement of the sub-screen 52 and displayed on the reduced screens (thumbnails) as the icons 54 through the display unit 50.

As described above, the sub-screen 52 indicating the second characteristic is displayed so as to overlap the position corresponding to the second area on the main screen 51, in which the second characteristic is a different type from the first characteristic and the second area as an area desired by a user is specified on the main screen 51. As a result, it becomes easy for the user to visually grasp the different characteristics in the desired area. Thus, a time taken to comprehensively evaluate the result of the numerical value analysis may be drastically reduced, and the evaluation accuracy of the numerical value analysis result may be improved greatly.

In addition, when the user makes the sub-screen 52 move on the main screen 51 by a mouse operation, the second characteristic according to position of the moving sub-screen 52 may be displayed on the sub-screen 52 and icon(s) 54 so as to follow the motion of the sub-screen 52. As a result, it becomes further easy for the user to visually grasp the different characteristics in the desired area while moving the sub-screen 52. Thus, while the time taken to comprehensively evaluate the result of the numerical value analysis is further reduced, and the evaluation accuracy of the numerical value analysis result is further improved.

In addition, in a case in which the user selects a characteristic that is to be displayed on the sub-screen 52, the user may grasp, by referring to the reduced screen (thumbnail) as the icon 54, a content displayed on the sub-screen 52 when the user has selected an icon 54. Thus, a desired characteristic may be selected and displayed reliably in the desired area.

In addition, when a certain icon 54 has been selected through a mouse operation of the user, display data used to display a sub-screen 52 is generated in advance in the background processing, where the display data indicates a characteristic other than a characteristic corresponding to the certain icon 54. As a result, display data for a characteristic is generated in advance, where the characteristic is probably desired to be selected next and displayed on the sub-screen 52, so that a desired characteristic is displayed on the sub-screen 52 in a short time when the user has selected an icon 54 corresponding to the desired characteristic. Thus, a time taken to comprehensively evaluate the result of the numerical value analysis may be further reduced.

In addition, at this time, the second area smaller than the first area is a target for generating a display data, and an target area for generating the display data is may be narrowed down as compared with a case in which display data is generated for the entire area, that is, the first area as a target. Accordingly, a time taken for the display processing may be drastically reduced.

### <4> a Specific Display Example

With reference to FIGS. 9 to 15, there is described below a specific display example by the characteristic display function of the information processing device 10 according to the embodiment.

FIG. 9 is a diagram illustrating an example of a display state of the main screen 51 indicating a vector diagram of a flow rate distribution as a first characteristic. FIG. 10 is a diagram illustrating an example of a display state when the sub-screen 52 indicating a contour diagram of a temperature distribution as a second characteristic is displayed on the main screen 51 illustrated in FIG. 9.

In the example illustrated in FIG. 9, there is displayed the main screen 51 through the display unit 50, where the main screen 51 indicates the first characteristic (here, flow rate vector diagram indicating a flow rate distribution) in the first area of the display target, that is, the analysis target. The first area is, for example, an area of the entire substrate on which a plurality of components is mounted.

At this time, as illustrated in FIG. 10, the sub-screen 52 is displayed on the main screen 51 through the display unit 50 so as to overlap the position on the main screen 51 which corresponds to the second area. The sub-screen 52 indicates the second characteristic (here, temperature contour diagram indicating a temperature distribution) in the second area specified within the main screen 51 by the user. As described above, the second area is within the first area and narrower than the first area and is, for example, a desired area on which the user focuses and includes a component on a substrate.

In addition, as illustrated in FIG. 10, on the main screen 51, two icons 54 are displayed in the vicinity of the sub-screen 52. As each of the icons 54, a reduced screen (thumbnail) is used that has been obtained by reducing the sub-screen 52 displayed through the display unit 50 when the icon 54 had been selected. The two icons 54 illustrated in FIG. 10 respectively correspond to, for example, flow rate and pressure.

When the icon 54 corresponding to the pressure is selected through a click operation or the like in the display state illustrated in FIG. 10, the display content of the sub-screen 52 is switched from a temperature contour diagram corresponding to a temperature distribution to a pressure contour diagram or the like corresponding to a pressure distribution. When the display content of the sub-screen 52 is switched to the pressure contour diagram, the two icons 54 near the sub-screen 52 are switched to reduced screens corresponding to the flow rate and the temperature, respectively.

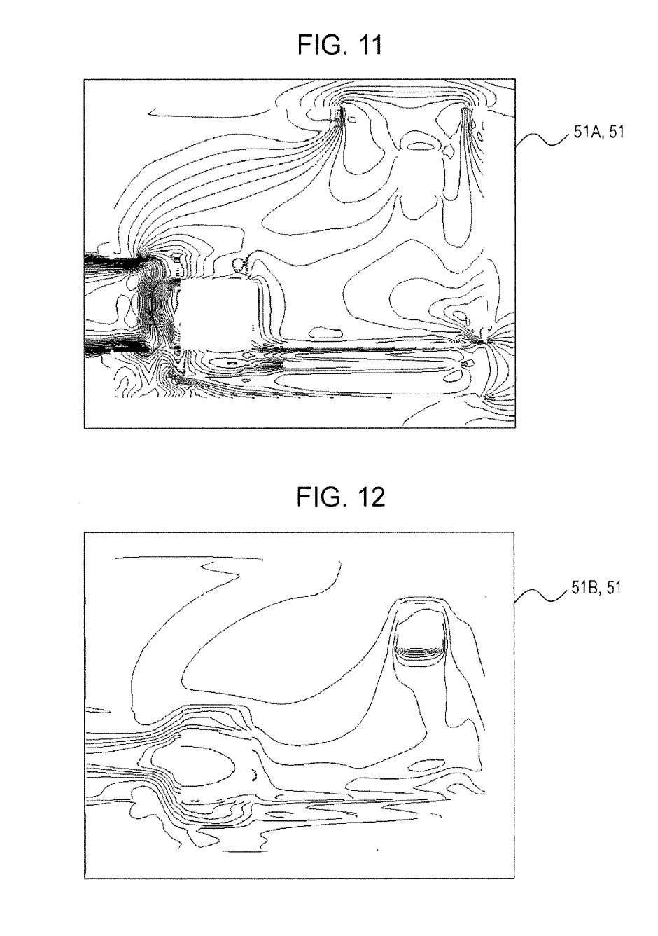

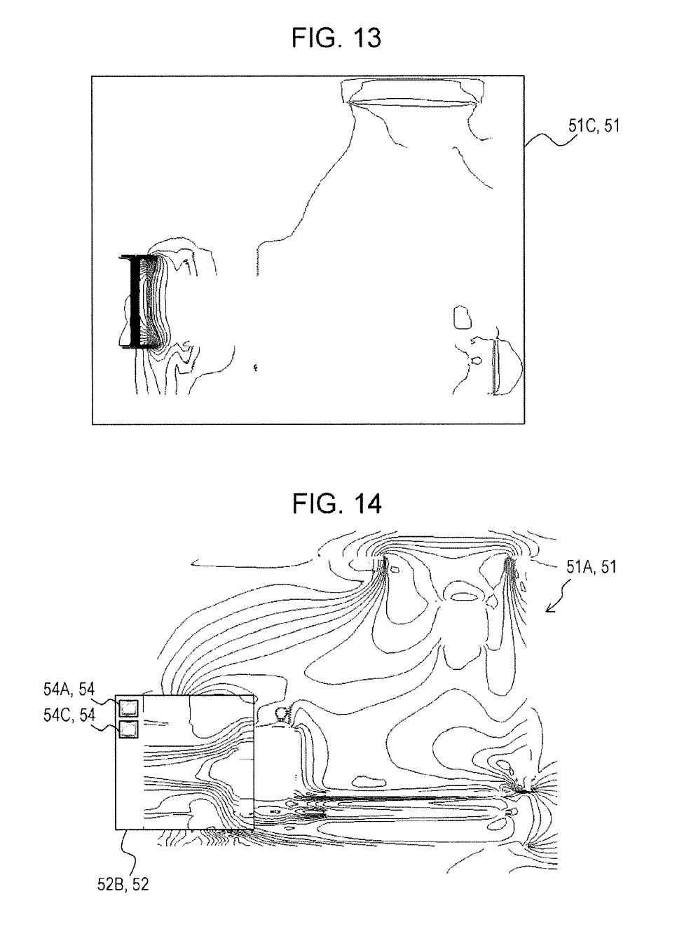

FIG. 11 is a diagram illustrating an example of a display state of the main screen 51A indicating a contour diagram of an air flow distribution (characteristic A) as the first characteristic. In addition, FIG. 12 is a diagram illustrating an example of the display state of the main screen 51B indicating a contour diagram of a temperature distribution (characteristic B) as the first characteristic. In addition, FIG. 13 is a diagram illustrating an example of the display state of the main screen 51 C indicating a contour diagram of a pressure distribution (characteristic C) as a first characteristic. It is assumed that, for example, in each of FIGS. 11 to 13, an area of the entire substrate on which a plurality of components is mounted (first area) is a display target.

Here, FIG. 14 is a diagram illustrating an example of a display state of the main screen 51A illustrated in FIG. 11. In FIG. 14, there are displayed the reduced screens 54A and 54C for characteristics A and C, respectively, and the sub-screen 52B indicating the contour diagram of the temperature distribution (characteristic B) as the second characteristic. In addition, FIG. 15 is a diagram illustrating an example a display state when the second characteristic displayed on the sub-screen 52 is switched from the contour diagram of the temperature distribution (characteristic B) to the contour diagram of the pressure distribution (characteristic C) through an operation for selecting the reduced screen 54C in the display state illustrated in FIG. 14.

In the example illustrated in FIG. 14, on the main screen 51A indicating the characteristic A illustrated in FIG. 11, the sub-screen 526 indicating the characteristic B in the second area specified by the user (see FIG. 12) is displayed through the display unit 50 so as to overlap the position corresponding to the second area on the main screen 51A. In addition, within the sub-screen 52B, there are displayed the icons 54A and 54C respectively corresponding to the characteristics A and C.

When the icon 54C corresponding to the characteristic C is selected through a click operation or the like in the display state illustrated in FIG. 14, a display content of the sub-screen 52 is switched from the contour diagram corresponding to the temperature distribution (see symbol 52B and FIG. 12) to the contour diagram corresponding to the pressure distribution (see symbol 52C and FIG. 13). In addition, the two icons 54 displayed on the sub-screen 52B are respectively switched, for example, to the reduced screen 54A corresponding to the characteristic A and the reduced screen 54B corresponding to the characteristic B.

### <5> Others

The embodiments of the technology discussed herein are described above in detail, but the technology discussed herein is not limited to such embodiments, and various modifications and changes may be made without departing from the spirit of the technology.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process for displaying a characteristic, the process comprising:
displaying, on a display, a main screen indicating a first characteristic in a first area of an object to be analyzed; and
displaying, on the display, a sub-screen indicating a second characteristic in a second area in the object, the second characteristic being different from the first characteristic, the second area being specified within the main screen, the sub-screen being overlapped on a portion within the main screen, the portion being corresponding to a portion of the second area in the first area.

2. The non-transitory computer-readable recording medium having stored therein a program for causing a computer to execute a process for displaying a characteristic according to claim 1, wherein
the computer includes a storage that stores data of the first characteristic and data of the second characteristic, and
the process further comprising:
generating the main screen indicating an image according to the data of the first characteristic which is read from the storage;
displaying the generated main screen on the display;
reading, when the second area is specified, the data of the second characteristic in the specified second area from the storage;
generating the sub-screen by using the read data of the second characteristic;
generating a display screen in which the generated sub-screen is overlapped on the portion; and
displaying the generated display screen on the display.

3. The non-transitory computer-readable recording medium having stored therein a program for causing a computer to execute a process for displaying a characteristic according to claim 1, the process further comprising:
displaying, on the display, when the sub-screen is caused to move on the main screen, the second characteristic in an area of the object, the area being an area through which the sub-screen passes due to movement of the sub-screen, the second characteristic following the movement of the sub-screen.

4. The non-transitory computer-readable recording medium having stored therein a program for causing a computer to execute a process for displaying a characteristic according to claim 1, the process further comprising:
displaying, on the display, a plurality of icons that respectively corresponds to different types of a plurality of characteristics, with the sub-screen; and
displaying, when a certain icon is selected from among the plurality of icons, a characteristic corresponding to the certain icon as the second characteristic on the display.

5. The non-transitory computer-readable recording medium having stored therein a program for causing a computer to execute a process for displaying a characteristic according to claim 4, wherein each of the plurality of icons is a reduced screen obtained by reducing the sub-screen displayed when the each of the plurality of icons is selected.

6. The non-transitory computer-readable recording medium having stored therein a program for causing a computer to execute a process for displaying a characteristic according to claim 5, the process further comprising:
displaying, on the reduced screen as the each of the plurality of icons, when the sub-screen is caused to move on the main screen, the second characteristic in an area of the object, the area being an area through which the sub-screen passes due to movement of the sub-screen, the second characteristic following the movement of the sub-screen.

7. The non-transitory computer-readable recording medium having stored therein a program for causing a computer to execute a process for displaying a characteristic according to claim 4, the process further comprising:
generating, in advance, display data used to display a sub-screen indicating a characteristic other than a characteristic corresponding to the certain icon from among the plurality of characteristic, in parallel with the processing in which the characteristic corresponding to the certain icon is displayed on the sub-screen.

8. An information processing device comprising:
a processor configured to
control a display state of a display, wherein
the display state is controlled so as to
display, on the display, a main screen indicating a first characteristic in a first area of an object, and
display, on the display, a sub-screen indicating a second characteristic in the object, the second characteristic being different from the first characteristic, the second area being specified within the main screen, the sub-screen being overlapped on a portion within the main screen, the portion being corresponding to a portion of the second area in the first area.

9. The information processing device according to claim 8, further comprising:
a storage that stores data of the first characteristic and data of the second characteristic, and
the processor further configured to
generate the main screen indicating an image according to the data of the first characteristic which is read from the storage,
display the generated main screen on the display,
read, when the second area is specified, the data of the second characteristic in the specified second area from the storage,
generate the sub-screen by using the read data of the second characteristic,
generate a display screen in which the generated sub-screen is overlapped on the portion, and
display the generated display screen on the display.

10. The information processing device according to claim 8, wherein
the processor further configured to
display, on the display, when the sub-screen is caused to move on the main screen, the second characteristic in an area of the object, the area being an area through which the sub-screen passes due to movement of the sub-screen, the second characteristic following the movement of the sub-screen.

11. The information processing device according to claim 8, wherein
the processor further configured to
display, on the display, a plurality of icons that respectively corresponds to different types of a plurality of characteristics, with the sub-screen, and
display, when a certain icon is selected from among the plurality of icons, a characteristic corresponding to the certain icon as the second characteristic on the display.

12. The information processing device according to claim 9, wherein
each of the plurality of icons is a reduced screen obtained by reducing the sub-screen displayed when the each of the plurality of icons is selected.

13. The information processing device according to claim 10, wherein
the processor further configured to
display, on the reduced screen as the each of the plurality of icons, when the sub-screen is caused to move on the main screen, the second characteristic in an area of the object, the area being an area through which the sub-screen passes due to movement of the sub-screen, the second characteristic following the movement of the sub-screen.

14. The information processing device according to claim 11, wherein
the processor further configured to
generate, in advance, display data used to display a sub-screen indicating a characteristic other than a characteristic corresponding to the certain icon from among the plurality of characteristic, in parallel with the processing in which the characteristic corresponding to the certain icon is displayed on the sub-screen.

15. A characteristic display method comprising:
displaying, by a computer, on a display, a main screen indicating a first characteristic in a first area of an object to be analyzed; and
displaying, on the display, a sub-screen indicating a second characteristic in a second area in the object, the second characteristic being different from the first characteristic, the second area being specified within the main screen, the sub-screen being overlapped on a portion within the main screen, the portion being corresponding to a portion of the second area in the first area.

16. The characteristic display method according to claim 15, the method further comprising:
generating the main screen indicating an image according to data of the first characteristic which is read from a storage;
displaying the generated main screen on the display;
reading, when the second area is specified, data of the second characteristic in the specified second area from the storage;
generating the sub-screen by using the read data of the second characteristic;
generating a display screen in which the generated sub-screen is overlapped on the portion; and
displaying the generated display screen on the display.

17. The characteristic display method according to claim 15, the method further comprising:
displaying, on the display, when the sub-screen is caused to move on the main screen, the second characteristic in an area of the object, the area being an area through which the sub-screen passes due to movement of the sub-screen, the second characteristic following the movement of the sub-screen.

18. The characteristic display method according to claim 15, the method further comprising:
displaying, on the display, a plurality of icons that respectively corresponds to different types of a plurality of characteristics, with the sub-screen; and
displaying, when a certain icon is selected from among the plurality of icons, a characteristic corresponding to the certain icon as the second characteristic on the display.

19. The characteristic display method according to claim 18, wherein each of the plurality of icons is a reduced screen obtained by reducing the sub-screen displayed when the each of the plurality of icons is selected.

20. The characteristic display method according to claim 19, the method further comprising:
displaying, on the reduced screen as the each of the plurality of icons, when the sub-screen is caused to move on the main screen, the second characteristic in an area of the object, the area being an area through which the sub-screen passes due to movement of the sub-screen, the second characteristic following the movement of the sub-screen.
